(19) United States
(12) Patent Application Publication
(10) Pub. No.: US 2022/0206180 A1
(43) Pub. Date: Jun. 30, 2022

(54) A DEVICE FOR DETERMINING BEDBUG ACTIVITY AND A METHOD FOR DETECTION OF BEDBUGS

(71) Applicant: IOT TELLTALES AB, Saltsjöbaden (SE)

(72) Inventor: Leobert William BUIS, Saltsjöbaden (SE)

(21) Appl. No.: 17/618,947

(22) PCT Filed: Jun. 24, 2020
(86) PCT No.: PCT/SE2020/050655

§ 371 Date: Dec. 14, 2021

(30) Foreign Application Priority Data
Jun. 28, 2019 (SE) 1930231-4

(51) Int. Cl. G01V 8/14; G01V 8/00; A01M 1/02

(52) U.S. Cl. CPC G01V 8/14; A01M 1/026; G01V 8/005

(57) ABSTRACT

A device (10) for determining bedbug activity comprises a housing (11) with openings (13), an insect detection zone (42) and pathways through the housing (11) that are traversing the insect detection zone (42). The device (10) has a light emitter (83) configured to direct light through the insect detection zone (42), an optical sensor (84) and a control unit. The light emitter (83) and re) the optical sensor (84) are arranged at a proximal end (43) of the insect detection zone (42) and a reflective surface is arranged at a distal end (44) of the insect detection zone (42). The optical sensor (84) is configured to receive light from the light emitter (83) via the reflective surface. The control unit controls the light emitter (83), the optical sensor (84) and the detection of bedbugs passing through the insect detection zone (42). A method for detection of bedbugs are presented.

### TECHNICAL FIELD

The present invention relates to a device for determining and monitoring insect activity, specifically bedbugs, and send detections to a remote place.

Also, the invention relates to a method for determining and monitoring insect activity, specifically bedbugs.

### BACKGROUND OF THE INVENTION

Bedbugs are a growing problem in public areas, hotels and private homes. Bedbugs are commonly found in hotels, apartment complexes, cruise ships, buses, airplanes, trains, and waiting rooms, all of which are places where many people pass through or stay for brief periods of time. Bedbugs are nocturnal and hide in small crevices and folds, for example in beds, fabrics, floors, furniture, wood and paper trash during the day. They reproduce in a very high rate, and once they have contaminated a space, it is very hard to get rid of them.

Bedbugs are spread by travelers, since they hide in bags and clothes and thus are moved from one place to another. It is important to detect the existence of bedbugs at an early stage to get a prosperous chance to stop the spread of them as quick as possible and hence save efforts and costs, and also physical pain for humans and pets. Contamination by bedbugs can cause serious damage to tourist and hotel business, as guests when being exposed and attacked by bedbugs may warn other guests of this unpleasantness and then downgrade the hotel.

Bed bugs like darkness and are active during the night and hide during the day. Bedbugs are nourishing on blood from humans, and since they are attracted by CO₂ from the aspiration from a sleeping person, they can be traced by poop tracks, small black dots, close to the head side of the bed. Bedbugs like narrow tight spaces and can be find along seems and edges, such as in tight areas at corners and in crevices between a mattress and the bed frame, and in fabric folds. If there are no humans in the bed, the bedbugs are hiding until anyone arrives. They can live for months or even years without food, i.e. blood.

Attempts have been made to present different methods and devices for detecting, monitoring and trapping bedbugs in order to limit and stop the spread of bedbugs.

The Australian patent application 2013200548 describes an apparatus to monitor for presence of bed bugs, which comprises a sensing arrangement including one or more sensors that is structured to analyze a substance received by the arrangement and generate one or more corresponding sensor signals. A controller operatively coupled to said sensing arrangement is structured with operating logic to determine if nitrophorin is included in the substance based on the one or more corresponding sensor signals and generate an output signal representative of the presence of bedbugs in response to the presence of nitrophorin in the substance.

US 2013/0208114 presents a digital bedbug device that is an extended first alert peripheral electronic device for pest management professionals, which provide increased early warning notifications before a newly occurred infestation of bedbugs will develop. The device comprises a box with a chamber having a crack and crevice entrance. A video digital camera is arranged into the box that is electronical coupled to a monitor and/or a video recorder. The device is connected to a carbon dioxide tube and warm heat from infrared lights is supplied to the chamber.

WO 2017/212112 discloses a monitoring device for insects, such as bedbugs, which comprises an elongated member constituting a furniture leg having a space inside and at least one opening where insects may enter, where the opening is connected to the space by a pathway that is inclined and slippery so that an insect entering the opening will slide to the space. Corresponding arrangement and method for bedbug monitoring are also presented.

U.S. Pat. No. 9,664,813 describes an automated insect monitoring system that comprises a housing with an interior chamber having a floor, a crevice for access to the interior chamber from the outside of the automated insect monitoring system and a light source. The light source is arranged to illuminate a portion of the floor and a multi-pixel optical sensor is arranged within the housing so that multiple pixels of the optical sensor each correspond to a unique segment of the floor. A processing circuit is arranged within the housing and is configured to receive and analyze optical data from the multi-pixel optical sensor to detect the intrusion of an insect into the interior chamber by comparing most recently received optical data to previously received optical data, and to generate an indication in response to detecting the intrusion of the insect into the interior chamber.

WO 2018/217639 presents a pest control device that comprises a sensor including a sensor cell wherein a surface of the sensor cell is coated with an agent that reacts with a targeted biochemical analyte secreted by pests. A controller is coupled to the sensor and is configured to receive sensor data from the sensor cell that is indicative of a change in sensor mass detected on the surface of the sensor cell, where the rate of change correlates to the increase in concentration of targeted biochemical analyte. The controller determines whether the change of rate in the sensor mass based on the received data exceeds a predefined threshold rate and transmits a pest detection alert notification to a server in response to a determination that the rate of change exceeds the threshold rate.

Currently available devices to monitor and trap bedbugs often include some type of biological or chemical substances, such as CO₂, and are generally designed for either trapping bedbugs or counting the number of bedbugs. These devices have limitations regarding functionality and performance, they are expensive to manufacture and are bulky in construction. To detect the presence of bedbugs is crucial to limit the spread as soon as possible. Accordingly, there is a need for an improved device that enables to detect and monitor the presence of bedbugs in a space or room at an early stage.

### SUMMARY OF THE INVENTION

An object of the present invention is to mitigate or eliminate one or more deficiencies and disadvantages of the prior art, such as the above-identified, singly or in any combination, by providing a device according to the appended patent claims.

In a first aspect the invention relates to a device for determining and monitoring the presence of bedbugs in a room or location, when bedbugs have entered the device placed in the room.

According to a first embodiment said device comprises a housing having several openings for insects and having an insect detection zone arranged within the housing. Further, the device comprises a light emitter configured to direct light through the insect detection zone, an optical sensor configured to receive light from the insect detection zone and a control unit.

One or more pathways for insects are arranged through the housing, where each pathway is traversing the detection zone. The control unit is configured to control the light emitter and the optical sensor and to detect the passing of an insect through the insect detection zone. The light emitter and the optical sensor are arranged at a proximal end of the insect detection zone and a reflective surface is arranged at a distal end of the insect detection zone, where the optical sensor is configured to receive light from the light emitter via the reflective surface.

Further, the device comprises a power source, for example a battery. The power source or the battery is chargeable via a charging port arranged at a short side of the device. According to an alternate embodiment, the power source is charged by means of an integrated solar panel arranged at the device for providing indoor harvesting.

The optical sensor is an infrared sensor. In alternate embodiments the optical sensor is a photo transistor or a radio frequency sensor.

The light emitter is a diode that is emitting infrared light. In an alternate embodiment the light emitter is an emitter configured to emit photons having a wavelength of between 340 nm and 15 cm within the electromagnetic spectrum.

According to a first embodiment the insect detection zone is dimensioned between 50 mm and 400 mm in length, and more preferably between 100 mm and 300 mm, and most preferably between 150 mm and 250 mm. Further, the insect detection zone has a width of between 3 mm and 20 mm, and more preferably between 5 and 10 mm. According to alternate embodiments the dimension of the detection zone could be chosen different from the above indicated.

The several openings are dimensioned between 3 mm and 10 mm in width and length. The number of openings is at least two but could be for example 6 to 20, or more. According to a first embodiment, the openings are arranged along both of the long sides of the housing. According to alternate embodiments, the openings could be arranged at only one long side of the housing, or in the lid or in the bottom of the device.

The one or more pathways start and finish at an opening in the housing. A space is provided between an opening and the insect detection zone. A direct light path for ambient light from an opening to the insect detection zone is prevented by light shields arranged in the space between an opening and the detection zone.

The control unit is configured to periodically pulse the light emitter and read the optical sensor reading, and the determination of the passing of an insect through the insect detection zone comprises performing a first reading, performing a second reading and determining that a difference between the first reading and second reading exceeds a threshold, which defines a detection of an insect. The detection of the insect is stored with a timestamp in a memory of the device.

Further, the device comprises a radio module, and the control unit is configured to periodically wake up the device and start the radio module for communication with a remote server and send detections stored. The radio communication is performed via a network interface. The network interface is preferably a wireless interface, such as the radio communication is performed via WiFi, Bluetooth LE, 2G/3G/4G, NB-IoT, LTE-M, SigFox, LoRa, Z-wave, or ZigBee.

Further, the housing comprises a chamber for storing an insect attractant, such as pheromones adapted for bedbugs.

In a second aspect the invention relates to a method to detect and monitor bedbugs that have entered the device.

The method according to the first embodiment comprises the step of providing a device comprising a housing with several openings for insects and an insect detection zone arranged within the housing, where the device further comprises a light emitter, an optical sensor and a control unit.

Further the method comprises the steps of arranging the light emitter and the sensor at a proximal end of the insect detection zone and providing a reflector and arranging the reflector at a distal end of the insect detection zone.

Thereafter, the method initiates the steps of periodically pulsing light from the light emitter through the insect detection zone and reading the optical sensor reading, performing a first reading and a second reading and determining that a difference between the first reading and the second reading exceeds a threshold, which defines a detection of insect.

Further, the method comprises the steps of storing the detection with a timestamp in a memory of the device, and periodically waking up the device and starting a radio module of the device for communication with a remote server and sending detections stored.

Further objects, features and advantages of the present invention will appear from the following detailed description, the attached drawings and the appended claims.

### BRIEF DESCRIPTION OF THE DRAWINGS

In order to explain the invention, embodiments of the invention will be described below with reference to the drawings, in which:

FIG. 1 is a perspective view of a device according to the invention,

FIG. 2 is a side view of the device from a long side thereof showing openings for insects,

FIG. 3 is a view of the device from a short side thereof showing a charging port,

FIG. 4 is a top view of the device according to a first embodiment where a lid of the device is removed,

FIG. 5 is a perspective view of an enlarged part of the device in FIG. 4 showing the interior thereof,

FIG. 6 is a bottom view of the lid showing a chamber for insect attractants,

FIG. 7 is a side view of the lid showing the chamber for insect attractants,

FIG. 8 is a block diagram showing components of the device according to a first embodiment,

FIG. 9 is a flow chart showing steps of a method for detection of and monitoring bedbugs that are entering or have entered the device, and

FIG. 10 is a diagram showing the detection of bedbugs that have entered the device.

Same reference numerals have been used to indicate the same parts in the figures to increase the readability of the description and for the sake of clarity.

### DESCRIPTION OF EMBODIMENTS OF THE INVENTION

Specific embodiments of the invention will now be described with reference to the accompanying drawings. This invention may be embodied in many different forms and should not be construed as limited to the embodiments set forth herein; these embodiments are provided so that this disclosure will be thorough and complete, and will fully convey the scope of the invention for those skilled in the art. The terminology used in the detailed description of the embodiments illustrated in the accompanying drawings is not intended to be limiting of the invention.

The device 10 according to the invention is configured to determine and detect insect activity, especially from bedbugs, in a room or location and then inform about the presence of bedbugs to an administrator at a remote place.

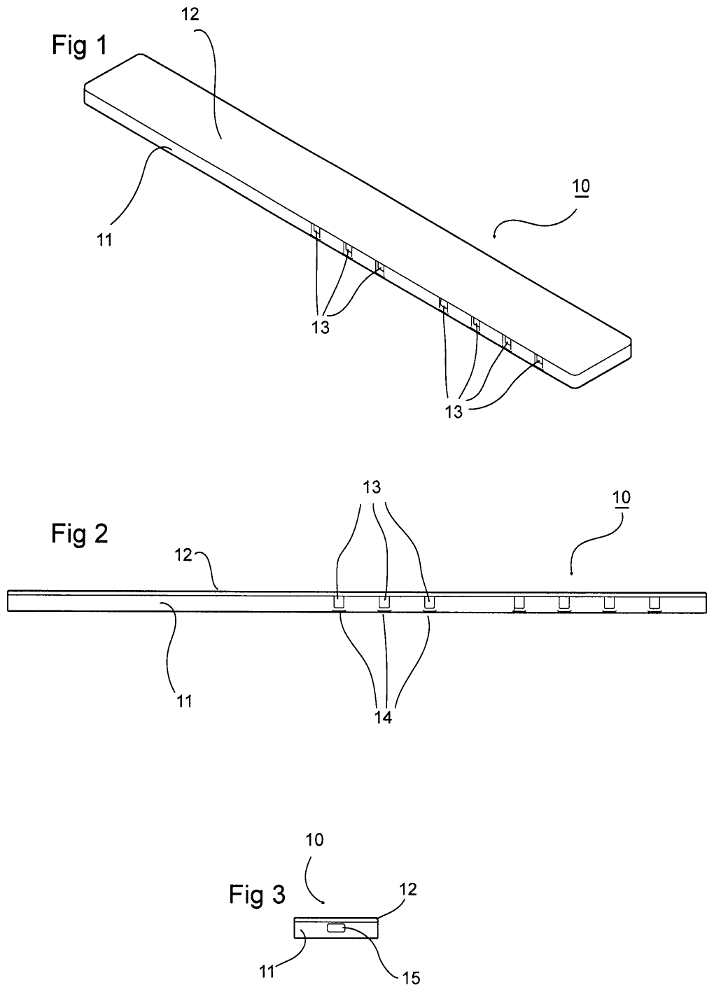

FIG. 1 shows schematically a perspective view of the device 10. The device 10 has an elongated housing 11 with a lid 12. According to a first embodiment, several openings 13 are arranged along each long side of the housing 11 for letting bedbugs enter the device 10. According to alternate embodiments the openings are arranged at only one of the long sides of the housing 11, or in the lid 12 of the housing 11 or in the bottom of the housing 11.

FIG. 2 illustrates the device 10 from a side view showing the openings 13 arranged at intervals along each long side of the housing 11. The openings 13 are adapted for letting in bedbugs into the device 10, where a lower edge 14 of each of the openings 13 has a phased radius to facilitate the entering for the bedbugs.

The openings 13 are dimensioned between 3 mm and 10 mm in width and length. The number of openings is at least two but could be for example 6 to 20, or more. According to a first embodiment, the openings are arranged along both of the long sides of the housing 11. According to alternate embodiments, the openings could be arranged at only one long side of the housing 11, or in the lid 12 or in the bottom of the device 10.

FIG. 3 shows the device 10 from a short side where a port 15 for charging a power source is arranged. The port 15 is configured for power supply to the device 10, such as a USB-port, a proprietary connector, inductive charging port, etc.

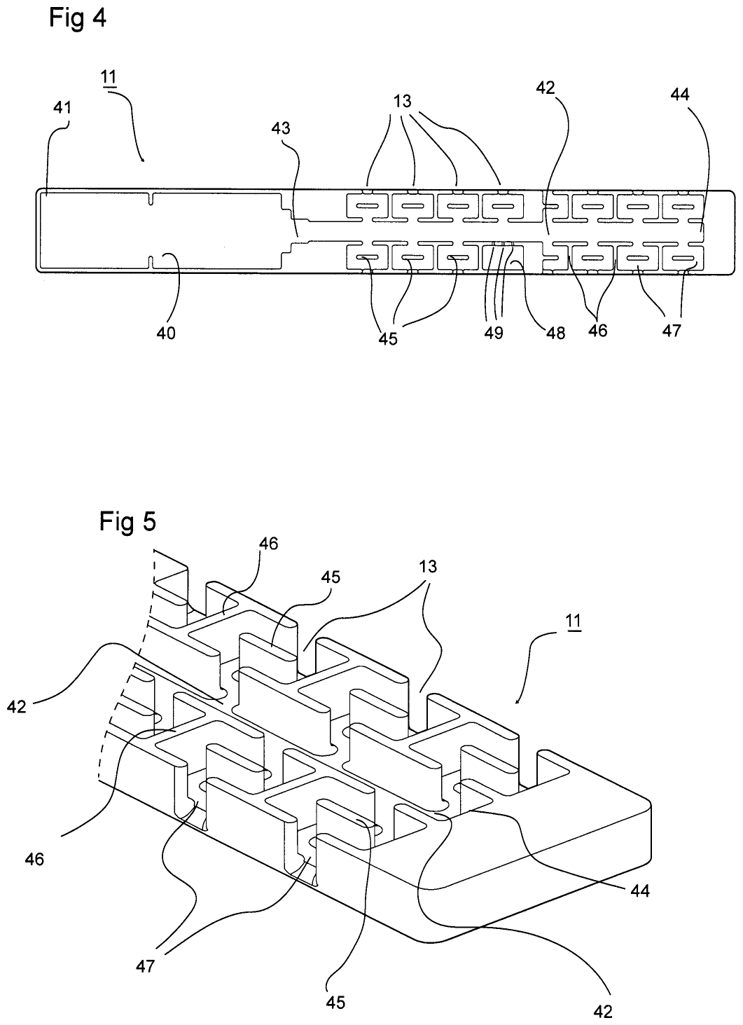

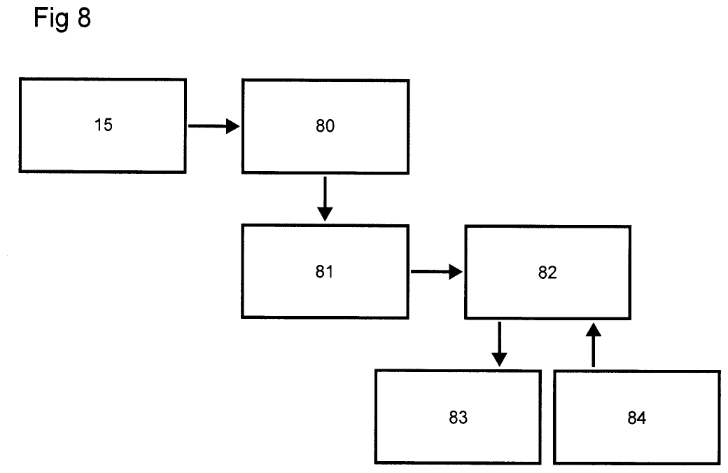

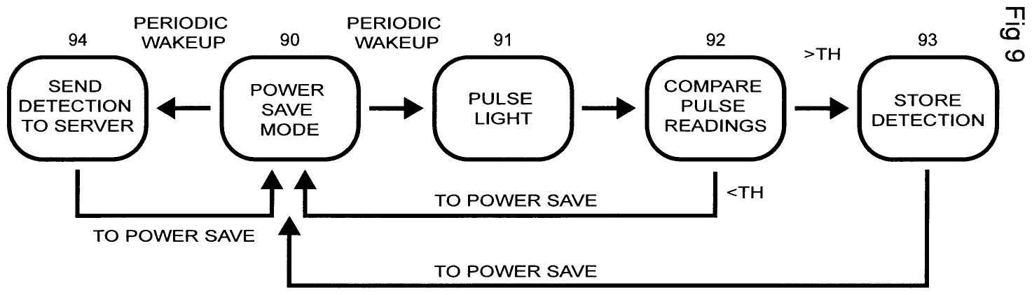

FIG. 4 illustrates the housing 11 of the device 10, where the lid 12 is removed. A compartment 40 is arranged at a proximal end 41 of the housing 11, which is adapted for arrangement of a control unit (not shown) and a power source 81 (shown in FIG. 8). The power source is for example a battery and is arranged close to the port 15. The control unit comprises a CPU and electronics. Further, the device 10 comprises a radio module 82 (shown in FIG. 8) that is arranged within the compartment 40. The radio module is for example configured to operate via WiFi, Bluetooth LE, 2G/3G/4G, NB-IoT, LTE-M, SigFox, LoRa, Z-wave, or ZigBee electronics.

The housing 11 of the device 10 comprises an insect detection zone 42 for detection of bedbugs that have entered the housing 11 through the openings 13. The insect detection zone 42 is arranged within and along the housing 11 and has a proximal end 43 and a distal end 44. Pathways for insects start and finish from one opening 13 to another one, where each pathway is traversing the insect detection zone 42. For example, a pathway starts at an opening 13 at one long side of the housing 11 and ends at another opening 13 at the other long side of the housing or ends at another opening 13 at the same long side of the housing 11.

According to a first embodiment the insect detection zone is dimensioned between 50 mm and 400 mm in length, and more preferably between 100 mm and 300 mm, and most preferably between 150 mm and 250 mm. Further, the insect detection zone 42 has a width of between 3 mm and 20 mm, and more preferably between 5 and 10 mm. According to alternate embodiments the dimension of the insect detection zone 42 could be chosen different from the above indicated.

A light emitter 83 (shown in FIG. 8) is arranged at the proximal end 43 of the insect detection zone 42 and is configured to direct light through the insect detection zone 42. An optical sensor 84 (shown in FIG. 8) is arranged at the proximal end 43 of the insect detection zone 42 and is configured to receive light from the insect detection zone 42. A reflector or a reflective surface is arranged at the distal end 44 of the insect detection zone 42. The optical sensor 84 is configured to receive light from the light emitter 83 via the reflective surface. The reflective surface is made of aluminum tape or other reflective material.

The light emitter is for example a diode that is emitting infrared light, such as an IR LED, or is an emitter configured to emit photons with a wavelength of between 340 nm and 15 cm within the electromagnetic spectrum. The optical sensor 84 is for example a photo transistor, such as an infrared sensor, or a radio frequency sensor.

The control unit is configured to control the light emitter 83 and the optical sensor 84, wherein the control unit is configured to determine the passing of an insect through the insect detection zone 42, which will be described below in connection with FIG. 9.

A space is provided between each of the openings 13 and the detection zone 42, where means are arranged to prevent that ambient light from an opening will reach the detection zone 42. According to a first embodiment light shields 45 are arranged in such way that these are blocking a direct line of sight between each of the openings 13 and the insect detection zone 42. The light shields 45 are arranged in parallel or inclined to the long sides of the device 10, hence the insects can walk around but ambient light from light bulbs or windows in the room is blocked from entering the insect detection zone 42.

According to the first embodiment, the light shields 45 are configured as walls which are arranged at a distance from the openings 13. By arrangement of partitions 46 within and across the space, perpendicular to the long sides of the device 10, sections 47 are formed for each opening 13. These sections 47 will attract bedbugs due to the small dimensions thereof, and this invite them to build nests when they are inactive, i.e. when they not are searching for food.

According to alternative embodiments, the light shields 45 may be Z-, V- or L-shaped. Other means for preventing that ambient light will disturb the detection of bed bugs entering the detection zone 42 are light absorbent walls, which also will minimize reflections.

FIG. 5 is a perspective view of an enlarged part of the device 10 without the lid, which shows the construction of an interior of the housing 11 according to the first embodiment, where the partitions 46 are forming sections 47 for each opening 13 and where light shields 45 are arranged in each section 47.

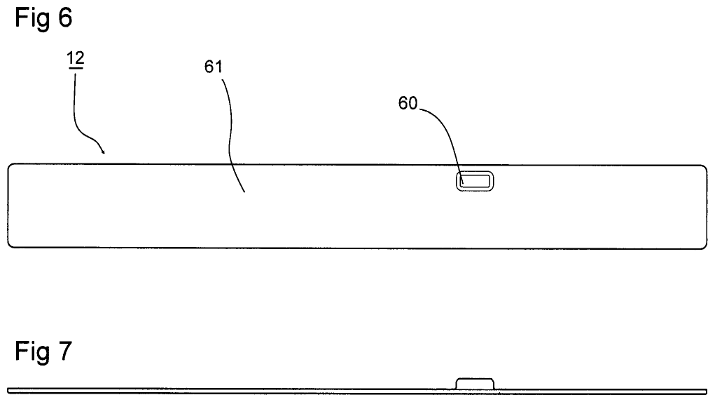

FIG. 6 is a bottom view of the lid 12 showing a chamber 60 for containing an insect attractant, which is arranged at a bottom side 61 of the lid 12. The chamber 60 is housed in a second compartment 48 of the housing 11 (shown in FIG. 4) when the lid 12 is assembled to the housing 11. The chamber 60 is configured to slowly dispense the attractant into the insect detection zone 42 through slots 49 (shown in FIG. 4) arranged at a side of the second compartment 48 facing the insect detection zone 42. The attractant is for example pheromones adapted for bedbugs.

FIG. 7 is a side view of the lid 12 showing the chamber 60 protruding from the bottom side 61 of the lid 12.

FIG. 8 is a block diagram showing components of the device 10 according to a first embodiment. The device 10 comprises the port 15 configured for charging electronics 80 of the device 10 and the power source 81, which then will supply power to the radio module 82, the light emitter 83 and the optical sensor 84. Normally, the power source 81 of the device 10 is charged regularly; for example once a week, once a month or once a year depending on the power consumption needed for the device 10, and will then operate without continuous charging to avoid cables and wires, which will be explained in detail below.

The housing 11 and the lid 12 are made of a polymeric material, such as PVC, PC, PE or PP, or a thermoplastic elastomer. The polymeric material should block light, which can be achieved by adding pigments to the polymer granulates at moulding, and the material is radio transparent to permit radio communication between the device 10 and a server at a remote site.

FIG. 9 is a flow chart illustrating steps of the method for detection of bedbugs entering the device 10. To secure that the device 10 is able to operate for a determined time period before the power source 81 has to be charged, it is essential to set the device 10 in power save mode most of the time, which is done in a step 90. In this step 90 detection and radio communication are turned off, resulting in a very low power consumption for the power source 81. The power source 81 is for example a battery according to a first embodiment of the device 10.

The device 10 is configured to wake up periodically, for example typically one time per second. When the device is waked up in a step 91, it will pulse the light emitter 83 one time during a short time period, e.g. typically one millisecond, while radio communication remains turned off. After the light emitter 83 has sent the pulse, a reading will be made by the optical sensor 84 when the light is reflected back by the reflective surface.

Directly after the light emitter 83 has sent a pulse, a reading will be made by the optical sensor, such as a photo transistor, and this reading will be compared to the previous pulse reading in a next step 92.

A detection has been made if the difference between readings is above a certain threshold TH, which will occur when an insect (bedbug) blocks the light normally being reflected back by reflector. Radio communication remains turned off.

A detection is performed and is stored in a device memory with a timestamp in a step 93, if the difference D between a first and second pulse reading is above the set threshold TH, which will occur when a bedbug blocks the light that normally is reflected back by the reflector. During step 93 radio communication remains turned off and the device 10 will thereafter return to power save mode 90. If the difference D between a first and second pulse reading is not above a set threshold TH, there is no detection to store and the device will return to power save mode 90.

The device 10 is configured to wake up periodically, e.g. typically one time per day, for sending stored detections to a backend server at a remote site in a step 94. The device 10 will then start radio communication and start a communication channel with the backend server for sending any detections that have been performed and stored. Thereafter, the device 10 will return to power save mode 90.

It should be understood that the wake up of the device 10 for sending stored detections can be made more often via the control unit, such as once per hour or every second hour, etc. However, it is important to operate the device 10 in power save mode most of the time to secure that the pulsing and reading can be continuously repeated without charging the power source 81.

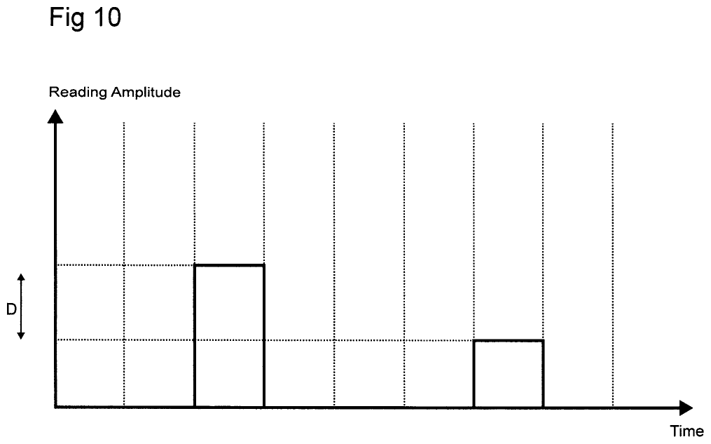

FIG. 10 is a diagram illustrating the detection of a bedbug entering the device 10. Directly after the light emitter 83 has sent a pulse, a reading will be made by the optical sensor 84, and the reading will be compared to the previous reading. A detection is made if the difference D in amplitude between a first pulse and a second pulse is above a specific threshold TH, which will occur when a bedbug blocks the light in the insect detection zone 42 that normally will be reflected back by the reflective surface.

The mechanical assembly of the device 10 is designed with intention to eliminate or minimize the effect from ambient light from light bulbs or windows. The algorithm of the control unit will take variations of ambient light into account to avoid false positive detections. A detection will only be made when the change in reflection shows the characteristics of bedbugs entering the insect detection zone 42 of the device 10.

In alternative embodiments, for example when detections must be performed faster, the detection algorithm can be improved by performing very rapid measurements during a longer time period, such as one pulse reading per millisecond during a time period of 5 seconds, which can be initiated as soon as a change in pulse reading is detected above the set threshold. In this case, it would be possible to analyse movement characteristics of different insects.

The inventive device 10 is designed to be arranged preferably at a lower surface of a bed close to the bedhead, where bedbugs often are hiding in crevices and folds.

The inventive device 10 is specifically useful in situations such as during holiday times when hotels are booked up and guests are changing frequently. The device 10 enables the administrator to quickly alert the service manager and staff to close a specific room and clean it when detections of insects, and specifically bedbugs, have been registered and sent to the backend server at the remote site.

The description above shall be considered as an exemplification of the principles of the invention and are not intended to limit the invention to the specific embodiments as illustrated. Other embodiments than the ones described can exist within the scope of protection, for example an alternative embodiment of the device can have a different design of the housing 11.

It should be emphasized that the term “comprise/comprising” when used in this specification is taken to specify the presence of stated features, integers, steps, or components, but does not exclude the presence or additions of one or more other features, other elements or steps. Reference signs in the claims are provided as clarifying examples and shall not be construed as limiting the scope in any way.

1. A device for determining bedbug activity, the device comprising:
a housing having several openings for bedbugs and having an insect detection zone arranged within the housing,
a light emitter configured to direct light through the insect detection zone-,
an optical sensor configured to receive light from the insect detection zone-,
one or more pathways for bedbugs through the housing, where each pathway starts and finishes from one opening to another one and is traversing the insect detection zone,
a control unit configured to control the light emitter and the optical sensor, wherein the control unit is configured to detect the passing of a bedbug through the insect detection zone, wherein:
the light emitter and the optical sensor are arranged at a proximal end of the insect detection zone and a reflective surface is arranged at a distal end of the insect detection zone, and wherein the optical sensor is configured to receive light from the light emitter via the reflective surface,
the control unit is configured to periodically pulse the light emitter and read the optical sensor reading, and wherein the determination of the passing of a bedbug through the insect detection zone comprises:
performing a first reading,
performing a second reading, and
determining that a difference D between the first reading and second reading exceeds a threshold TH, which defines a detection of a bedbug, and
the detection of a bedbug is stored with a timestamp in a memory of the device.

2. The device of claim 1, further comprising a radio module and wherein the control unit is configured to periodically wake up the device and start the radio module for communication with a remote server and send detections stored.

3. The device of claim 2, wherein the radio communication is performed via a network interface.

4. The device of claim 3, wherein the network interface is a wireless interface.

5. The device of claim 4, wherein the radio communication is performed via WiFi, Bluetooth LE, 2G/3G/4G, NB-IoT, LTE-M, SigFox, LoRa, Z-wave, or ZigBee.

6. The device of claim 1 further comprising a power source.

7. (canceled)

8. The device according to claim 6, wherein the power source is charged by means of an integrated solar panel arranged at the device.

9. The device of claim 1, wherein the optical sensor is a photo transistor.

10. The device of claim 1, wherein the optical sensor is an infrared sensor.

11. The device of claim 1, wherein the optical sensor is a radio frequency sensor.

12. The device of claim 1, wherein the light emitter is a diode that is emitting infrared light.

13. The device of claim 1, wherein the light emitter is configured to emit photons having a wavelength of between 340 nm and 15 cm within the electromagnetic spectrum.

14. The device of claim 1, wherein the insect detection zone is dimensioned between 50 mm and 500 mm in length, and more preferably between 100 mm to 300 mm, and most preferably between 150 mm and 250 mm.

15. The device of claim 1, wherein the several openings are dimensioned between 3 mm to 10 mm in height and width.

16. The device of claim 1, wherein the several openings are arranged along long sides of the housing or at the lid of the housing or at the bottom of the housing.

17. The device of claim 1, wherein a space is provided between an opening and the insect detection zone.

18. The device of claim 17, wherein a direct light path for ambient light from an opening to the insect detection zone is prevented by light shields arranged in the space between an opening and the insect detection zone.

19. The device of claim 18, wherein partitions are arranged within and across the space forming sections for each of the openings.

20. The device of claim 1, wherein the housing comprises a chamber for storing an insect attractant.

21. A method for detection of bedbugs comprising:
providing a device comprising a housing with several openings for bedbugs and with an insect detection zone arranged within the housing, where the device further comprises a light emitter, an optical sensor and a control unit,
arranging the light emitter and the optical sensor at a proximal end of the insect detection zone,
providing a reflector and arranging the reflector at a distal end of the insect detection zone,
periodically pulsing light from the light emitter through the insect detection zone and reading the optical sensor reading,
performing a first reading and a second reading and determining that a difference D between the first reading and the second reading exceeds a threshold TH, which defines a detection of a bedbug,
storing the detection with a timestamp in a memory of the device,
periodically waking up the device and starting a radio module of the device for communication with a remote server and sending detections stored, and
returning to power save mode after sending the detections stored.
